(19) United States
(12) Patent Application Publication
(10) Pub. No.: US 2013/0134240 A1
(43) Pub. Date: May 30, 2013

(54) WATER DISTRIBUTION ASSEMBLY FOR A SELF-PROPELLED MECHANIZED IRRIGATION SYSTEM

(71) Applicant: Craig S. Malsam, Omaha, NE (US)

(72) Inventor: Craig S. Malsam, Omaha, NE (US)

(73) Assignee: VALMONT INDUSTRIES, INC., Omaha, NE (US)

(21) Appl. No.: 13/816,315

(22) PCT Filed: Aug. 11, 2011
(86) PCT No.: PCT/US11/47395

§ 371 Date: Feb. 11, 2013

Related U.S. Application Data
(60) Provisional application No. 61/372,505, filed on Aug. 11, 2010.

(51) Int. Cl. A01G 25/16

(52) U.S. Cl. CPC A01G 25/16
USPC 239/728; 239/735

(57) ABSTRACT

A variable pump assembly may be disposed or coupled to a water release point of an irrigation assembly. The variable pump assembly may be configured to control an output water pressure as a function of the irrigation assembly's location or position. As the irrigation assembly travels an irrigation path, the variable pump assembly may dynamically change the output water pressure of the water and/or applicants released from the water release point to provide sufficient irrigational coverage to the land.

### BACKGROUND

The present disclosure is in the technical field of self-propelled mechanized irrigation systems. More particularly, the present disclosure is in the technical field of water and/or applicant distribution and fluid dynamics associated with self-propelled mechanized irrigation systems.

Self-propelled mechanized irrigation systems have become an essential component in present day commercial agriculture since their introduction over sixty years ago. The first irrigation systems suffered from many mechanical and design shortcomings that have resulted in many improvements throughout their existence. One notable improvement in the art was the introduction and development of end guns and corner systems. These designs applied water and applicants to areas beyond the end of the main mechanized irrigation structure. However, even with these advancements, areas of the field remained beyond the range of the prior art, leaving crops without access to the water, fertilizers, herbicides, or pesticides being applied, therefore resulting in sub-optimal crop health and growth.

The self-propelled mechanized irrigation system may be any type of irrigation system known in the art, with two prevalent irrigation systems being the center pivot system and the linear move system. Center pivot mechanized irrigation systems generally travel in a circular path around the field. However, due to the general square or rectangular plots of farmland, there is an area of farmland outside the center pivot device's reach, even when corners and end guns are used, that typically receives insufficient coverage. Linear mechanized irrigation systems generally travel in a straight line down the field. However, due to the general irregular boundaries of square or rectangular fields, there is an area of farmland outside of the linear device's reach that typically receives insufficient irrigation coverage.

There are many benefits that may be obtained by overcoming this shortcoming in the prior art, including, but not limited to: increased yields, increased disease and pest control, and increased acreage in production. Therefore, a need exists in the art for an irrigation system with a water distribution assembly affixed to the outer end of the structure to provide for the application of water, fertilizers, herbicides, and pesticides to areas beyond the reach of the prior art.

### SUMMARY

The present disclosure is a variable pump assembly disposed or coupled to the outer-most end of the structure of a self-propelled mechanized irrigation system. The variable pump assembly may be configured to control an output water/applicant pressure as a function of the mechanized irrigation system's location in the field. As the mechanized irrigation system travels an irrigation path, the variable pump assembly may dynamically change the output water/applicant pressure of the water and/or applicant released from the outer most end of the mechanized irrigation structure to provide sufficient irrigational coverage to the land.

This Summary is provided solely to introduce subject matter that is fully described in the Detailed Description and Drawings. Accordingly, the Summary should not be considered to describe essential features nor be used to determine scope of the claims.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

The numerous advantages of the present disclosure may be better understood by those skilled in the art by reference to the accompanying figures in which:

FIG. 1 is a perspective view of a center pivot irrigation system;

FIG. 2 is a perspective view of an overhang of a center pivot irrigation system;

FIG. 3 is a block diagram of the variable pump assembly;

FIG. 4 is an example of a flowchart of the electronic speed control;

FIG. 5 is an example of a user-defined table for applicant distribution range versus machine position;

FIG. 6 is an example variable speed pump control versus range and cycle time;

FIG. 7 is an example of variable speed pump control versus machine speed;

FIG. 8 is a block diagram of the variable pump assembly in an second embodiment;

FIG. 9 is a perspective view of the applicant distribution of a center pivot equipped with an end gun;

FIG. 10 is a perspective view of the applicant distribution of a center pivot equipped with a corner system;

FIG. 11 is a perspective view of the applicant distribution of a Linear mechanized irrigation system equipped with an end gun; and

FIG. 12 is a perspective view of a center pivot and linear irrigation system equipped with the present disclosure.

### DETAILED DESCRIPTION

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

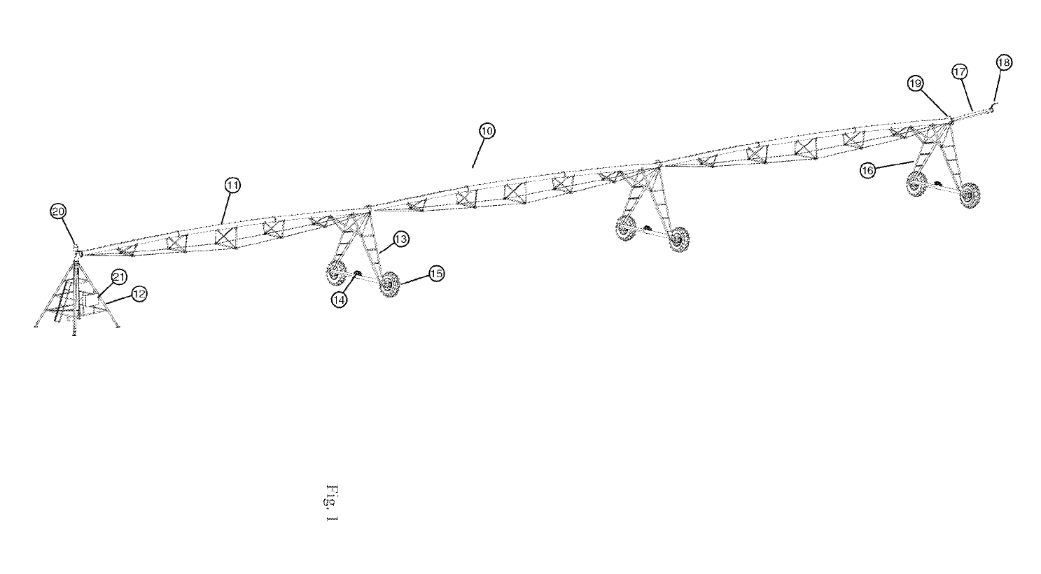

Referring now to the disclosure in more detail, in FIG. 1, there are two prevalent self-propelled irrigation system 10 types. The two prevalent self-propelled irrigation systems 10 are the center pivot system and the linear move system. FIG. 1 illustrates an embodiment of the present disclosure where the irrigation system 10 is a center pivot system 10. The center pivot system 10 may include a water conduit, a pipe, or a boom 11 that extends outwardly from a conventional center pivot structure 12. The water pipe 11 is comprised of a plurality of pipe sections joined together in an end-to-end relationship, which are supported upon a plurality of drive units 13. Each drive unit 13 has a drive means 14 of propelling the wheel 15 thereof. In most cases, the drive means 14 will comprise an electric motor that may be reversible so that the center pivot system 10 may be driven in either a forward direction or a reverse direction. Normally, the machine alignment on the center pivot system 10 is maintained by a mechanical linkage at each drive unit span joint, which operates a micro-switch that starts and stops the electric motor on the drive unit 13 to keep in line with the next span. The last drive unit 13 on the irrigation system 10 will be designated by reference numeral 16. Normally, a cantilevered boom 17, know as an overhang assembly 17, extends outwardly form the last drive unit 16 and has an end gun 18 mounted thereon that is actuated to irrigate areas outside the area covered by the water pipe between the center pivot structure and the last drive unit 13.

A speed control 19 is typically mounted on the last drive unit 16. Typically, the speed control 19 is a percent timer. The speed control 19 may also be a variable speed drive or other speed control device that is connected to the electric motor 14 on the last drive unit 16.

A position sensor is also mounted on the center pivot system 10. Typically, this is either an angle sensor 20 mounted at the center pivot structure 12 or a GPS receiver mounted on or near the last drive unit 16.

A conventional computer control panel 21 may be mounted on the center pivot structure. The computer control panel 21 may control many machine functions including, but not limited to: speed, direction, water on or off, irrigation system 10 start or stop, end guns on or off, and so forth. The computer control panel 21 may be connected to the angle sensor 20 and speed control 19, which in turn is connected to drive 14. The computer control panel 21 may also be configured to receive user defined inputs.

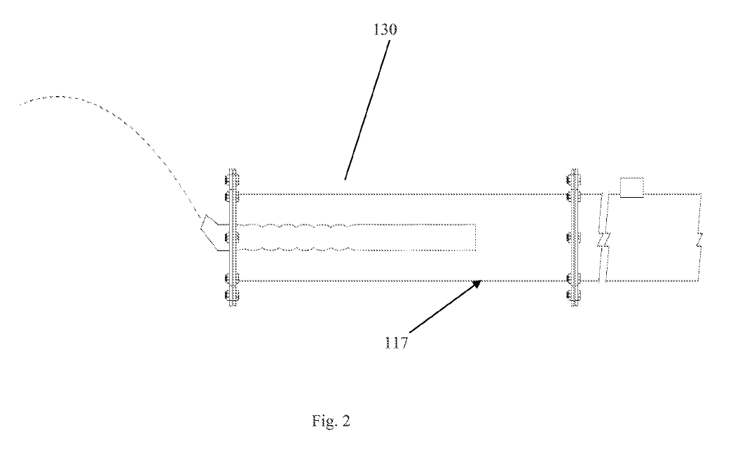

In more detail, referring to the disclosure of FIG. 2, the overhang assembly 117 may include a variable speed pump assembly 130 mounted or coupled to a water pipe of the overhang assembly. Specifically, the variable speed pump assembly 130 may be mounted or coupled inside the water pipe. The variable speed pump assembly 130 may be configured to control a water/applicant pressure as a function of the irrigation system's 10 position or location.

In further detail, referring to the disclosure of FIG. 3, the variable speed pump assembly 130 may include a variable speed pump, an electronic speed control, a power supply, and a telemetry means consisting of a power line carrier. However, the telemetry means may be anything in the current art including, but not limited to a serial bus, a spread spectrum radio, a VHF radio, a UHF radio, or the like.

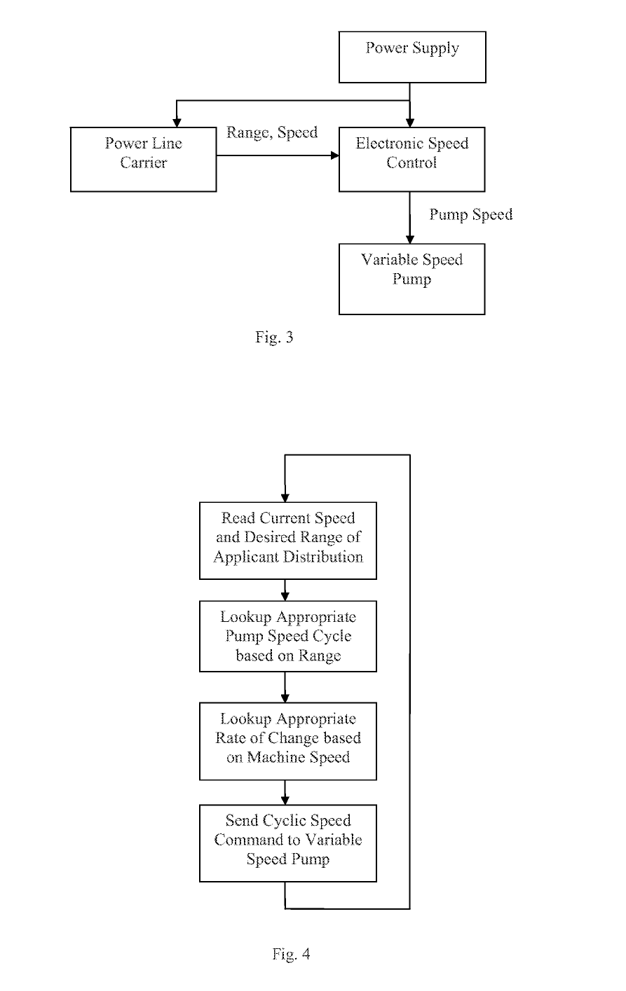

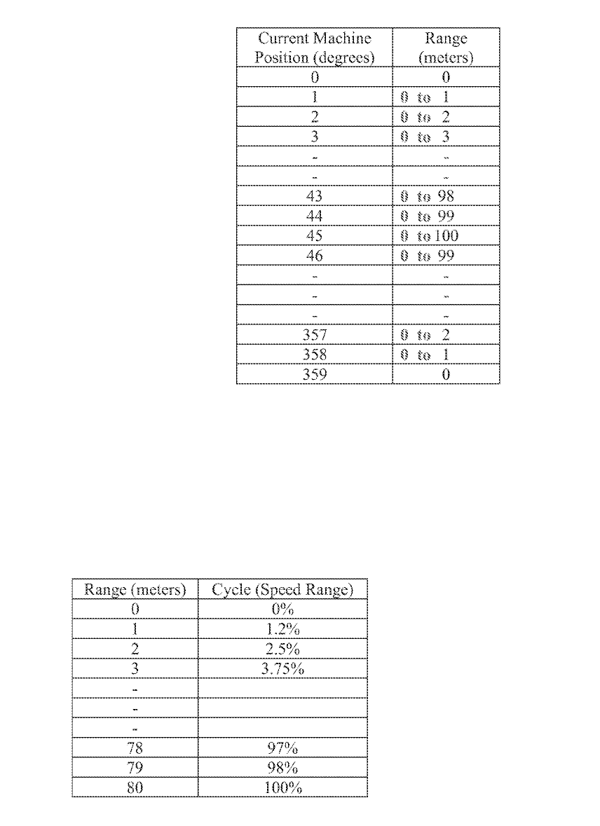

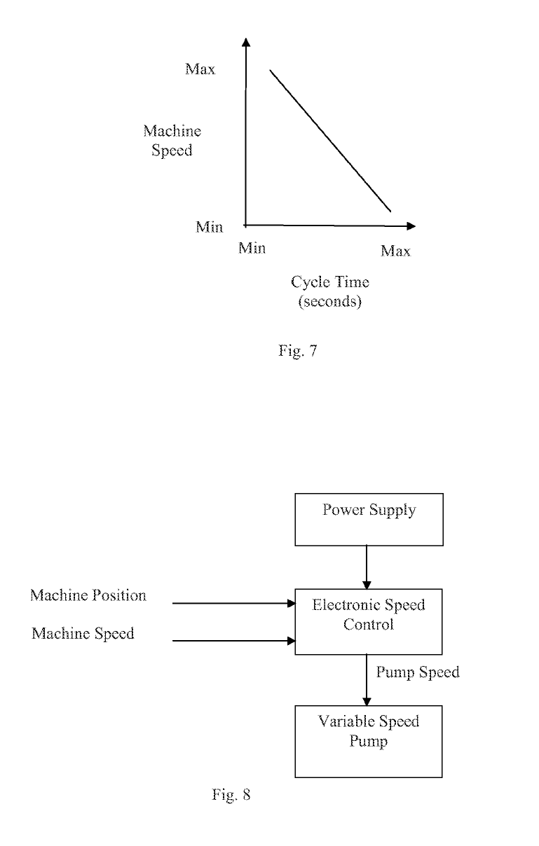

In further detail, FIG. 4 illustrates a flowchart of the electronic speed control 19. In use, the computer control panel 21 may contain a user-defined table (depicted in FIG. 5) indicating the desired water distribution range based on the current position of the center pivot structure. The computer control panel 21 transmits the desired range to the electronic speed control 19 of the variable speed pump assembly along with other parameters including the speed of the last drive unit. The electronic speed control 19 cycles the speed of the pump based on the desired range and the speed of the last drive unit 16 as illustrated in FIG. 6 and FIG. 7. The pump speed is cycled according to FIG. 6 to apply water and other applicants from the end of the overhang to the desired range and all areas in between. Similarly, the rate of change of pump speed is controlled according to FIG. 7 to ensure uniform application of water and/or applicants at any speed of the irrigation system 10.

In further detail, FIG. 8 illustrates an alternative implementation of the disclosure in which the variable speed pump assembly is not in communication with the computer control panel 21 and therefore does not contain a telemetry means. Instead, the variable speed pump assembly is in direct communications with the speed control and the position sensor. The table of FIG. 5 may be manually programmed into the electronic speed control via a user allowing the variable speed pump assembly to operate as described above. This implementation may be desirable to allow retrofitting of the present disclosure to existing mechanized irrigation systems 10.

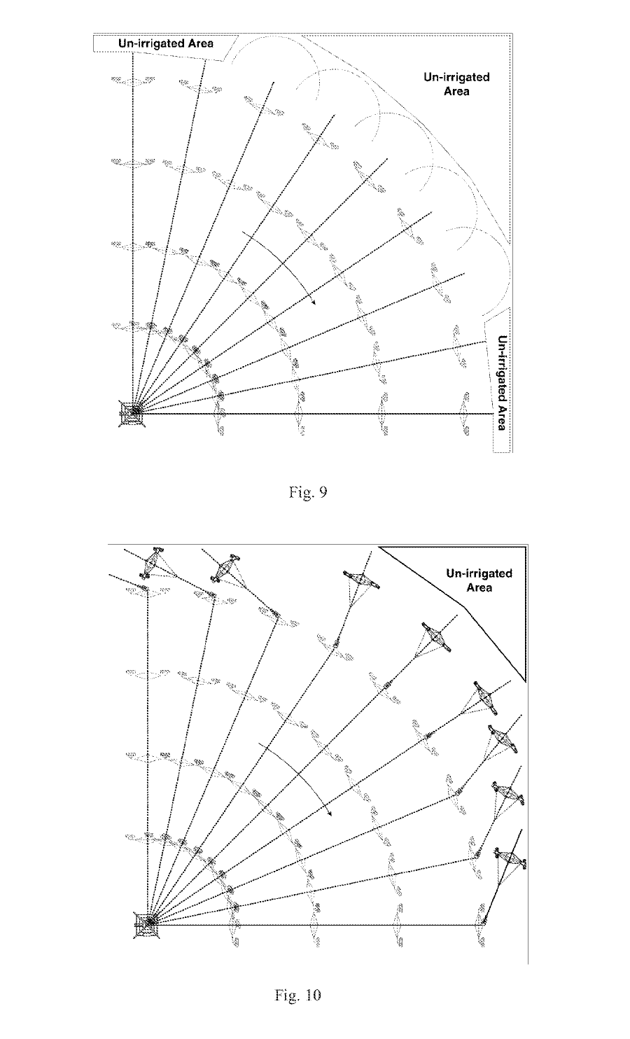

The advantages of the present disclosure may include, without limitation, the ability to apply water and/or applicants to 100% of the desired locations in the field. FIGS. 9 and 10 illustrate the irrigated and un-irrigated areas of a center pivot mechanized irrigation system 10 outfitted with an end gun and a corner arm, respectively. FIG. 11 illustrates the irrigated and un-irrigated areas of a linear mechanized irrigation system 10 outfitted with an end gun. Also, irrigation with an end gun provides water distribution at the set range of the end gun, but not in the intermediate range as depicted in FIG. 9 and FIG. 11.

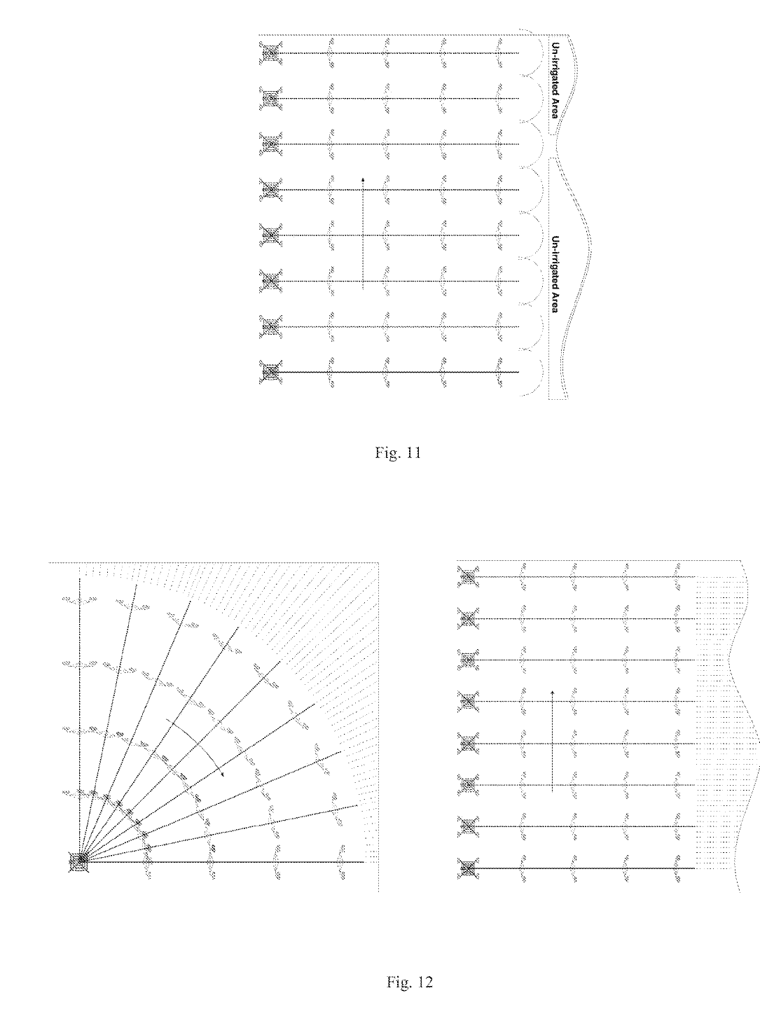

The advantages of the present disclosure are illustrated in FIG. 12, where water and/or applicants may be applied to 100% of the desired locations in the field and the uniformity of the application is not adversely affected by changes in the speed of the mechanized irrigation system.

While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

I claim:

1. An irrigation system comprising:
a water conduit;
a plurality of drive towers configured to support and move the water conduit;
a position sensor configured to determine a position of the irrigation system;
a variable speed pump assembly coupled to the water conduit, the variable speed pump assembly configured to control an applicant output pressure as a function of the position of the irrigation system.

2. The irrigation system of claim 1, wherein the position sensor comprises a GPS receiver coupled to one of the drive towers.

3. The irrigation system of claim 1, wherein the irrigation system is a center-pivot irrigation system.

4. The irrigation system of claim 3, wherein the position sensor comprises a GPS receiver coupled to the outer-most drive tower.

5. The irrigation system of claim 4, further comprising a control panel having a programmed logic configured to set an output pressure for the variable speed pump assembly based on the position of the outer-most drive tower.

6. The irrigation system of claim 1, further comprising a control panel in communication with the position sensor.

7. The irrigation system of claim 1, wherein the position sensor comprises an angle sensor.
